(19) United States
(12) Patent Application Publication
(10) Pub. No.: US 2005/0180423 A1
(43) Pub. Date: Aug. 18, 2005

(54) Device and method of network communication

(75) Inventors: Hsin-Tung Liao, Erlun Township (TW); Ming-Chen Weng, Minsyong Township (TW); Mao-Yuan Huang, Chiayi City (TW)

Correspondence Address: BACON & THOMAS, PLLC, 625 SLATERS LANE, FOURTH FLOOR, ALEXANDRIA, VA, 22314, US

(73) Assignee: Fine Appliance Corporation, Sindian City (TW)

(21) Appl. No.: 11/009,877

(22) Filed: Dec. 13, 2004

(30) Foreign Application Priority Data
Feb. 17, 2004 (TW) 093202260

(51) Int. Cl. H04L 12/28

(52) U.S. Cl. 370/392

(57) ABSTRACT

A device and method of network communication can receive a control/data signal from a computer motherboard via a storage interface bus and output a storage/network data packet to a network via a network connection port, so that the computer can access the network and a storage device such as hard disk via the device or the method of the present invention. Therefore, the cost of maintaining the storage device and the risk of destruction by computer virus is reduced. Wherein the device of the present invention includes a storage controller for converting the control/data signal into a storage signal, a network microprocessor for converting the storage signal into a storage data packet and a wireless/wired switching agent for converting the storage data packet and a network data packet into the storage/network data packet.

### BACKGROUND OF THE INVENTION

1. Field of the Invention

The present invention relates to a device and method of network communication.

2. Description of the Related Art

With its technological improvements, the computer is becoming a more and more common device. Because there are always some bugs existing in an operation system or application software, and hackers try to break into the operation system, software technicians must continuously update new hardware and download newer patches to avoid software or hardware failures and protect the system from the hackers. Furthermore, with the convenience and speedy data transmission on the Internet, network information sharing has become a significant communication tool, and the capability of network transmission has become one of the most importantly basic functions of a personal computer. Businesses use networking to increase the efficiency of data transmission and to overcome distance limitations to reduce costs.

Since personal computers utilize hard disks as a storage device, problems associated with hard disks can arise during system maintenance, such as the limitation of the storage capability, fragility, high temperature and noise during working, or even being put out of operation by a virus. Therefore, the newest technology is proposed to replace hard disks with a network resource to reduce manpower, cost and maintenance.

FIG. 1 is a schematic drawing of a personal computer, a storage device and a network card. A personal computer 11 has a storage device 13 (such as a hard disk) which is connected to a storage interface (such as an AT attachment interface, ATA)/(AT Attachment Packet Interface, ATAPI) of the personal computer 11 and sends or receives storage control signals and storage data from the personal computer 11. Furthermore, the personal computer 11 sends or receives network packets to the network via a network card 12 such as an Ethernet card. This personal computer 11 is adapted as a terminal in a typical business office; however, it is very difficult to maintain failure-free operations, and to upgrade the system.

Therefore, it is desirable to provide an network communication device having a storage interface with network functionality to mitigate and/or obviate the aforementioned problems.

### SUMMARY OF THE INVENTION

An objective of the present invention is to provide a device of network communication, which comprises: a storage controller connects to a computer motherboard via a storage interface bus and adapts to convert a control/data signal from the computer motherboard into a storage signal or converts the storage signal into the control/data signal; a network microprocessor adapts to convert the storage signal from the storage controller into a storage data packet or adapts to convert the storage data packet into the storage signal; and a switching agent connects to the computer motherboard via a extension slot and adapts to convert the storage data packet and a network data signal form the computer motherboard into a storage/network data packet and outputs the storage/network data packet to a network or adapts to convert the storage/network data packet into the storage data packet and the network data signal.

A further objective of the present invention is to provide a method of network communication, which includes: (A) obtaining the control/data signal; (B) converting the control/data signal to a storage signal and outputting the storage signal; (C) converting the storage signal into a storage data packet and outputting the storage data packet; (D) obtaining a network data signal; (E) converting the network data signal into the network data packet; and (F) converting the storage data packet and the network data packet into a storage/network data packet.

The method of the present invention further includes: (G) obtaining and converting the storage/network data packet from the network into the storage data packet and the network data packet; (H) converting the network data packet into the network data signal; (I) switching and converting the storage data packet into the storage signal; (J) converting the storage signal into the control/data signal; and (K) outputting the control/data signal to the computer motherboard.

The storage interface bus may be an ATA, ATAPI, SCSI, SATA, IEEE1394 or USB, and the extension slot may be an ISA, PCI, PCI-X or PCI-Express.

Other objects, advantages, and novel features of the invention will become more apparent from the following detailed description when taken in conjunction with the accompanying drawings.

### BRIEF DESCRIPTION OF THE DRAWINGS

FIG. 1 is a schematic drawing of a personal computer, a storage device and an ethernet card;

FIG. 2 is a schematic drawing of a personal computer according to the present invention;

FIG. 3 is a functional block diagram of the device of network communication according to the present invention with peripheral units;

FIG. 4 is an embodiment of a network microprocessor;

FIG. 5A to FIG. 5D are functional block diagrams of first to fourth embodiments of the switch agent 33;

FIG. 6 is a flowchart of a transmission procedure of a method of according to the present invention; and

FIG. 7 is a flowchart of a receipt procedure of a method of according to the present invention.

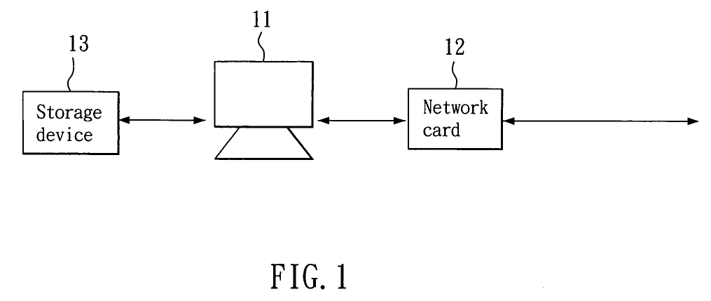

### DETAILED DESCRIPTION OF THE PREFERRED EMBODIMENT

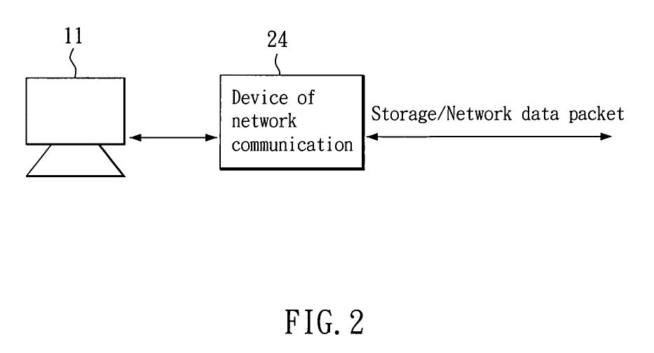

FIG. 2 is a schematic drawing of a personal computer with a device of network communication 24 of the present invention. A personal computer 11 receives and sends a storage/network data packet to a storage device of a remote server on a network via the device of network communication 24.

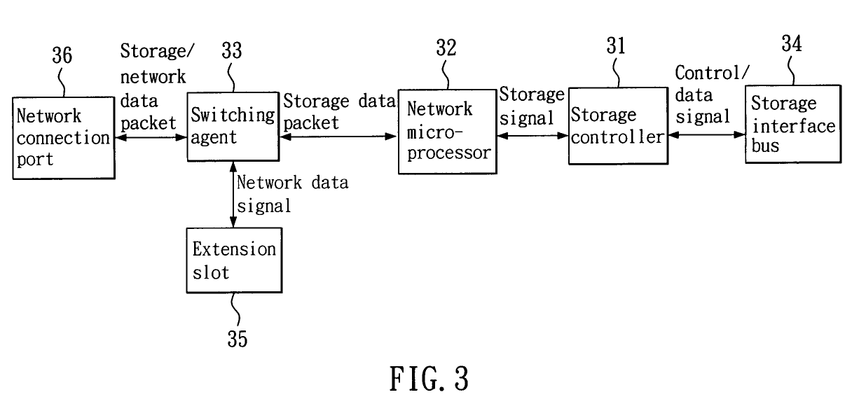

FIG. 3 is a functional block diagram of the device of network communication with peripheral units. The device of network communication 24 comprises a storage controller 31, a network microprocessor 32 and a switch agent 33. The storage controller 31 of the device of network communication 24 is connected to the personal computer 11 via a storage interface bus 34 and adapted to send or receive a control/data signal. The network microprocessor 32 is placed between the storage controller 31 and the switch agent 33. The storage controller 31 converts the control/data signal to a storage signal and sends it to the network microprocessor 32, or receives the storage signal sent from the network microprocessor 32 and converts it to the control/data signal and then sends the control/data signal to the storage interface bus 34. The network microprocessor 32 processes the storage signal to generate a storage data packet, and sends the storage data packet to the switch agent 33, or receives the storage data packet sent from the switch agent 33 and processes it to generate the storage signal that is sent to the storage controller 31. The switch agent 33 is capable of serving as a hub switch, which sends the storage data packet from the network microprocessor 32 to a network via a network connection port 36; furthermore, the switch agent 33 converts the network data signal sent from an extension slot 35 into a network data packet, and sends the network data packet to the network via the network connection port 36. Conversely, the network data packet sent from the network connection port 36 is divided into a storage data packet and a network data signal by the switch agent 33, then the storage data packet is sent to the network microprocessor 32 and the network data signal is sent to the extension slot 35 respectively. However, the existence of the extension slot 35 is depended on the demand of the user and is optional for the reason. The storage/network data packet from the network connection port 36 will be replaced with the storage data packet if the extension slot 35 is absent and the switch agent 33 just provides the function of switching.

The network microprocessor 32 may be an ARM7 (Samsung S3C4510B), an ARM9 (Samsung S3C2510A), an ARM10, a Broadcom processor (BCM 112X series or BCM 1250), an Intel processor (IXP series or IOP series), an RDC processor (RDC 1620C or RDC 2020C), a Motorola processor (MPC8272 series), a Realtek processor (RTL8181), or other similar types of microprocessors. The storage interface bus 34 can be ATA, ATAPI, small computer system interface (SCSI), serial AT attachment interface (SATA), Institute of Electrical and Electronics Engineers 1394 standard for high performance serial bus (IEEE1394), or universal serial bus (USB); the slot can be an Industry Standard Architecture expansion bus (ISA), peripheral component interconnect bus (PCI), PCI eXtended bus (PCI-X) or PCI Express bus (PCI-Express).

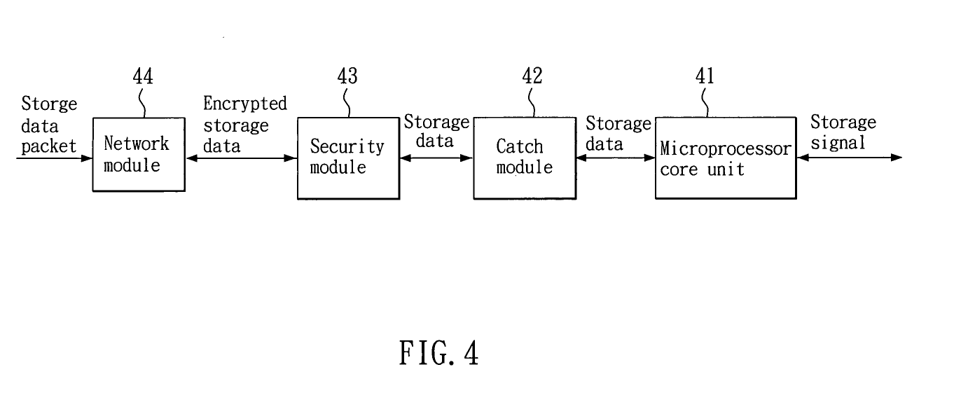

FIG. 4 is an embodiment of the network microprocessor 32. In this embodiment, the network microprocessor 32 comprises a microprocessor core unit 41, a cache module 42, a security module 43 and a network module 44. The cache module 42 and the security module 43 are used for controlling transmission speed and transmission security respectively. The microprocessor core unit 41 is adapted to convert the storage signal to the storage data, and one end of the microprocessor core unit 41 is connected to the storage controller 31 to send or receive the storage signal and another end is connected to the cache module 42 to send or receive the storage data. The cache module 42 is placed between the microprocessor core unit 41 and the security module 43, and is capable of buffering data signal transmissions and increasing the efficiency of data transmission. One end of the cache module 42 is connected to the microprocessor core unit 41 and another end is connected to the security module 43. The security module 43 is placed between the cache module 42 and the network module 44, and is capable of encrypting the storage data to increase data transmission security. One end of the security module 43 is connected to the cache module 42 to send or receive the storage data, and another end is connected to the network module 44 to send or receive encrypted storage data. The network module 44 converts the encrypted storage data to a storage data packet; similarly, the network module 44 receives and converts the storage data packet from the switch agent 33 to the encrypted storage data, and sends it to the security module 43 to decode.

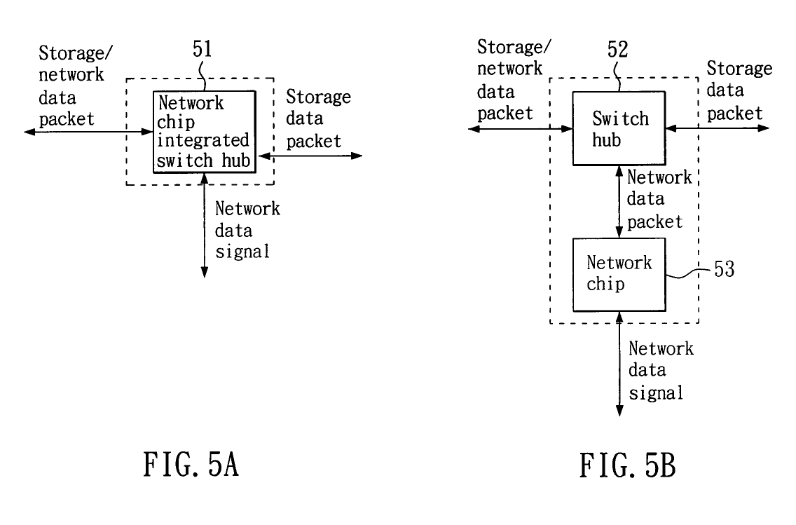

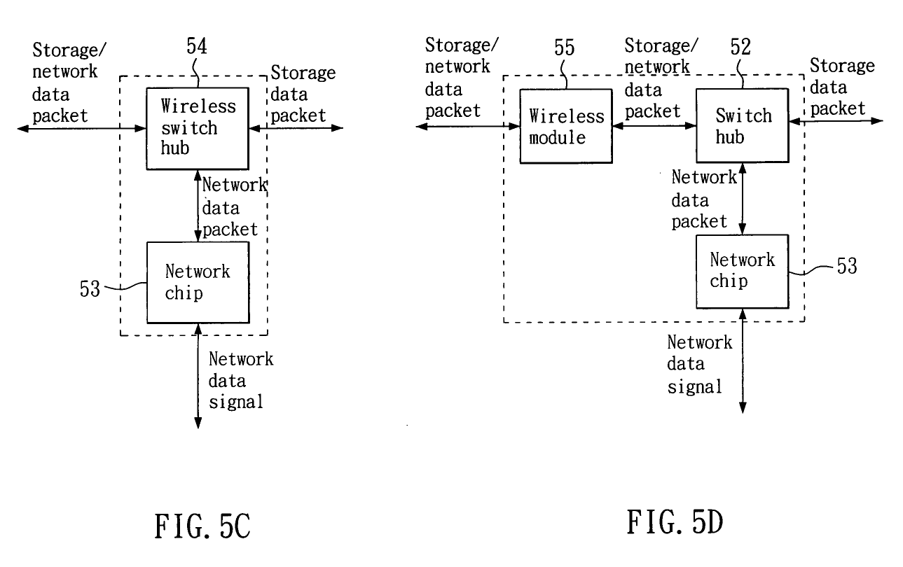

FIG. 5A to FIG. 5D are functional block diagrams of first to fourth embodiments of the switch agent 33. A network chip integrated with a switch hub 51 shown in FIG. 5A is the first embodiment of the switch agent 33, the network chip integrated with a switch hub 51 provides both functionalities of a standard switch hub and a standard network chip. The network chip integrated with a switch hub 51 converts the network data signal to the network data packet and sends it to the network connection port 36. Conversely, the network chip integrated with a switch hub 51 also converts the network data packet into the network data signal and the storage data packet. It is well known that the network chip integrated with a switch hub 51 switches the storage data packet to the network microprocessor 32 or the network connection port 36.

FIG. 5B shows a functional block diagram of the switch agent 33 according to a second embodiment, and the switch agent 33 comprises a switch hub 52 and a network chip 53. The network chip 53 converts the network data signal to the network data packet and sends the network data packet to the switch hub 52. The network chip 53 receives the network data packet from the switch hub 52 and converts it to the network data signal. The switch hub 52 is a standard network device and switches the storage/network data packet into the storage data packet and the network data packet, vice versa.

FIG. 5C shows a functional block diagram of the switch agent 33 according to a third embodiment, and the switch agent 33 comprises a wireless switch hub 54 and a network chip 53. The network chip 53 converts the network data signal to the network data packet and sends it to the wireless switch hub 54; conversely, the network chip 53 simultaneously converts the network data packet from the wireless switch hub chip 54 into the network data signal. The wireless switch hub 54 is a standard wireless network device and switches the storage/network data packet into the storage data packet and the network data packet, vice versa.

FIG. 5D shows a functional block diagram of the switch agent 33 according to a fourth embodiment of the present invention, and the switch agent 33 comprises a wireless module 55, a switch hub 52 and a network chip 53. The functions of the network chip 53 and the switch hub 52 are as described as above-mentioned and thus a detailed description is deemed unnecessary. The wireless module 55 is a standard wireless communication device and adapted to wirelessly transmit and receive the storage/network data packet. In the foregoing embodiments, the network chip 53 and the provided function thereof are optional and depended on the demand of the user.

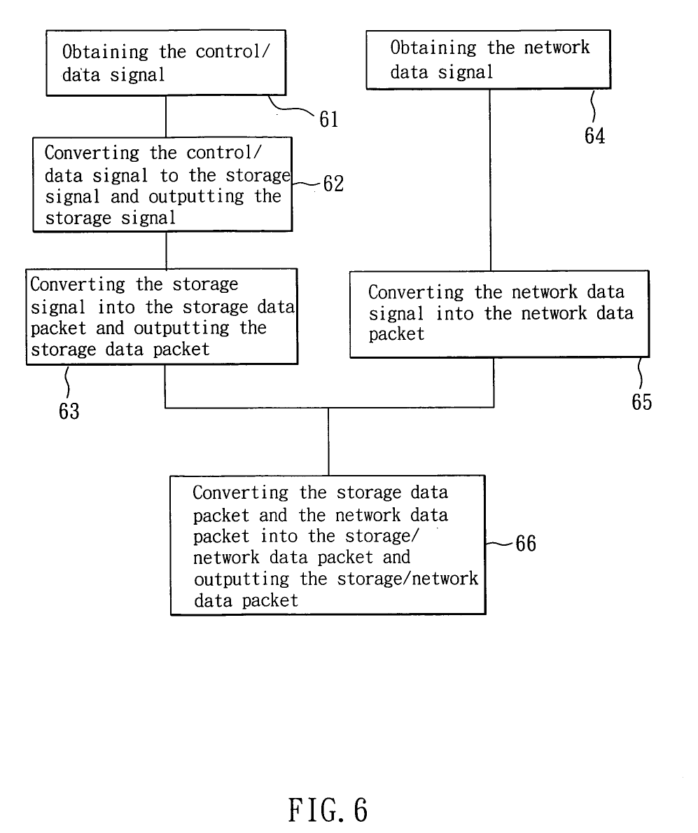

The method of network communication according to the present invention includes a transmission procedure and a receipt procedure. The transmission procedure of the method of network communication is shown in FIG. 6 and comprises the following steps:

Step 61: obtaining the control/data signal.

Step 62: converting the control/data signal to the storage signal and outputting the storage signal.

Step 63: converting the storage signal into the storage data packet and outputting the storage data packet.

Step 64: obtaining the network data signal.

Step 65: converting the network data signal into the network data packet.

Step 66: converting the storage data packet and the network data packet into the storage/network data packet and outputting the storage/network data packet. Because the network chip 53 and the provided function thereof are optional, the steps 64 and 65 are also optional, and the step 66 will be replaced with switching the storage data packet into the storage/network data packet and outputting the storage/network data packet.

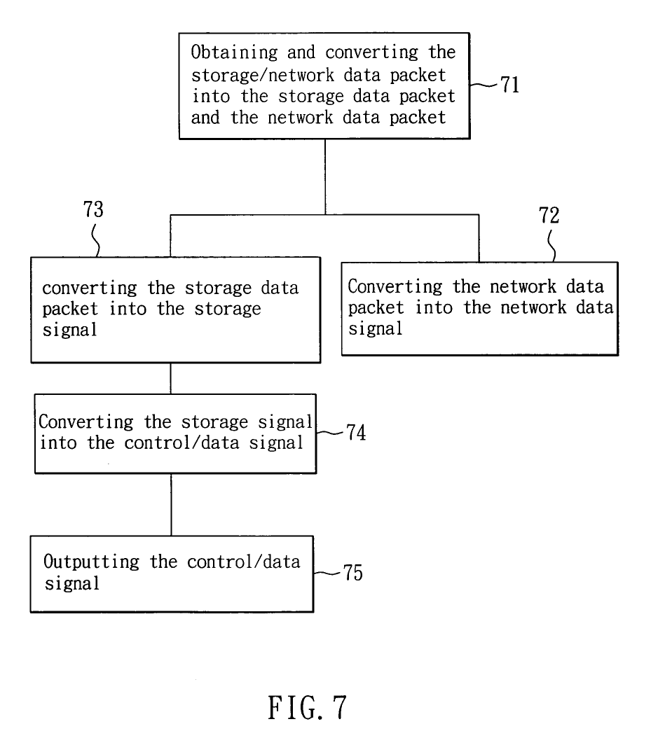

The receipt procedure of the method of network communication is shown in FIG. 7 and comprises the following steps:

Step 71: obtaining and converting the storage/network data packet into the storage data packet and the network data packet.

Step 72: converting the network data packet into the network data signal.

Step 73: converting the storage data packet into the storage signal.

Step 74: converting the storage signal into the control/data signal.

Step 75: outputting the control/data signal into the computer motherboard. Because the network chip 53 and the provided function thereof are optional, the step 72 is also optional, and the step 71 will be replaced with obtaining and switching the storage/network data packet into the storage data packet.

Although the present invention has been explained in relation to its preferred embodiment, it is to be understood that many other possible modifications and variations can be made without departing from the spirit and scope of the invention as hereinafter claimed.

1. A device of network communication, comprising:
a storage controller connected to a computer motherboard via a storage interface bus and adapted to convert a control/data signal from the computer motherboard into a storage signal or convert the storage signal into the control/data signal;
a network microprocessor adapted to convert the storage signal from the storage controller into a storage data packet or adapted to convert the storage data packet into the storage signal; and
a switching agent connected to the computer motherboard via a extension slot and adapted to convert the storage data packet and a network data signal form the computer motherboard into a storage/network data packet and output the storage/network data packet to a network or adapted to convert the storage/network data packet into the storage data packet and the network data signal.

2. A device of network communication, comprising:
a storage controller connected to a computer motherboard via a storage interface bus and adapted to convert a control/data signal from the computer motherboard into a storage signal or convert the storage signal into the control/data signal; and
a network microprocessor adapted to convert the storage signal from the storage controller into a storage data packet and output the storage/network data packet to a network or adapted to convert the storage data packet from the network into the storage signal.

3. The device as claimed in claim 1, wherein the network microprocessor further comprises:
a microprocessor core unit adapted to convert the storage signal into storage data and output the storage data; and
a network module adapted to convert the storage data to the storage data packet and output the storage data packet.

4. The device as claimed in claim 2, wherein the network microprocessor further comprises:
a microprocessor core unit adapted to convert the storage signal into storage data and output the storage data; and
a network module adapted to convert the storage data to the storage data packet and output the storage data packet.

5. The device as claimed in claim 1, wherein the network microprocessor further comprises:
a microprocessor core unit adapted to convert the storage signal into storage data and output the storage data;
a cache module adapted to cache the storage data;
a security module adapted to encrypt the storage data from the cache module into an encrypted storage data; and
a network module adapted to convert the encrypted storage data into the storage data packet.

6. The device as claimed in claim 2, wherein the network microprocessor further comprises:
a microprocessor core unit adapted to convert the storage signal into storage data and output the storage data;
a cache module adapted to cache the storage data;
a security module adapted to encrypt the storage data from the cache module into an encrypted storage data; and
a network module adapted to convert the encrypted storage data into the storage data packet.

7. The device as claimed in claim 1, wherein switching agent further comprises:
a network chip adapted to convert the network data signal into a network data packet or convert the network data packet into the network data signal; and
a switch hub adapted to switch the network data packet and the storage data packet into the network/storage data packet or switch the network/storage data packet into the network data packet and the storage data packet.

8. The integrated device as claimed in claim 1, wherein switching agent further comprises:
a network chip adapted to convert the network data signal into a network data packet or convert the network data packet into the network data signal;
a switch hub adapted to switch the network data packet and the storage data packet into the network/storage data packet or switch the network/storage data packet into the network data packet and the storage data packet; and
a wireless module adapted to transmit and receive the network/storage data packet wirelessly.

9. The device as claimed in claim 1, wherein the network microprocessor is a microprocessor.

10. The device as claimed in claim 2, wherein the network microprocessor is a microprocessor.

11. The integrated device as claimed in claim 1, wherein the storage interface bus is an ATA, ATAPI, SCSI, SATA, IEEE1394 or USB.

12. The integrated device as claimed in claim 2, wherein the storage interface bus is an ATA, ATAPI, SCSI, SATA, IEEE1394 or USB.

13. The integrated device as claimed in claim 1, wherein the extension slot is an ISA, PCI, PCI-X or PCI-Express.

14. A method of network communication for inputting a control/data signal from a computer motherboard and outputting a storage/network data packet into a network, comprising:
(A) obtaining the control/data signal;
(B) converting the control/data signal to a storage signal and outputting the storage signal;
(C) converting the storage signal into a storage data packet and outputting the storage data packet;
(D) obtaining a network data signal;
(E) converting the network data signal into the network data packet; and
(F) converting the storage data packet and the network data packet into a storage/network data packet.

15. A method as claimed in claim 14, wherein the method further comprising:
(G) obtaining and converting the storage/network data packet into the storage data packet and the network data packet;
(H) converting the network data packet into the network data signal;
(I) converting the storage data packet into the storage signal;
(J) converting the storage signal into the control/data signal; and
(K) outputting the control/data signal.

16. A method of network communication for inputting a control/data signal from a computer motherboard and outputting a storage/network data packet into a network, comprising:
(A) obtaining the control/data signal;
(B) converting the control/data signal to a storage signal and outputting the storage signal;
(C) converting the storage signal into a storage data packet and outputting the storage data packet; and
(D) switching the storage data packet into a storage/network data packet.

17. A method as claimed in claim 16, wherein the method further comprising:
(E) obtaining and switching the storage/network data packet into the storage data packet;
(F) converting the storage data packet into the storage signal;
(G) converting the storage signal into the control/data signal; and
(H) outputting the control/data signal.

18. The method as claimed in claim 14, wherein the control/data signal is obtained from the computer motherboard via a storage interface bus of ATA, ATAPI, SCSI, SATA, IEEE1394 or USB.

19. The method as claimed in claim 16, wherein the control/data signal is obtained from the computer motherboard via a storage interface bus of ATA, ATAPI, SCSI, SATA, IEEE1394 or USB.

20. The method as claimed in claim 14, wherein the network data signal is obtained from the computer motherboard via an extension slot of ISA, PCI, PCI-X or PCI-Express.
